(19) United States
(12) Patent Application Publication
(10) Pub. No.: US 2021/0115181 A1
(43) Pub. Date: Apr. 22, 2021

(54) A METHOD FOR PRODUCING AN OPEN CELL RIGID POLYURETHANE FOAM

(71) Applicant: COVESTRO DEUTSCHLAND AG, Leverkusen (DE)

(72) Inventors: Hideki WADA, Kawanishi-city, Hyogo-pref. (JP); Kei ODANI, Tatsuno-city, Hyogo prefecture (JP); Takayasu TANABE, Osaka-city, Osaka prefecture (JP); Yukio YASUDA, Osaka-city, Osaka prefecture (JP)

(21) Appl. No.: 16/463,677

(22) PCT Filed: Nov. 24, 2017
(86) PCT No.: PCT/EP2017/080355

§ 371 Date: May 23, 2019

(30) Foreign Application Priority Data
Nov. 25, 2016 (JP) 2016-229551

(51) Int. Cl. C08G 18/18; C08G 18/30; C08G 18/32; C08G 18/48; C08G 18/66; C08G 18/76; C08J 9/00; C08J 9/08; C08L 71/02

(52) U.S. Cl. CPC C08G 18/1825; C08G 2110/005; C08G 18/302; C08G 18/3206; C08G 18/3218; C08G 18/329; C08G 18/4837; C08G 18/6688; C08G 18/7664; C08J 9/0061; C08J 9/08; C08L 71/02; C08J 2201/022; C08J 2205/05; C08J 2205/10; C08J 2207/04; C08J 2375/08; C08J 2483/12; C08G 2110/0025; C08G 18/1833

(57) ABSTRACT

To produce quickly and easily an open cell rigid polyurethane foam having a uniform and low density, a method for producing an open cell rigid polyurethane foam is provided, the method comprising foaming a mixed liquid of (1) a polyol-containing component comprising (a) a polyol mixture, (b) a catalyst, and (c) a foaming agent (c), and (2) a polyisocyanate component. The foaming agent consists of water and an adduct of a primary or secondary amine compound and carbon dioxide, the amount of the water is 10 to 80 parts by mass based on 100 parts by mass of the polyol mixture, and the amount of the adduct is 1 to 20 parts by mass based on 100 parts by mass of the polyol mixture.

### CROSS REFERENCE TO RELATED APPLICATION

This application is a national stage application under 35 U.S.C. § 371 of PCT/EP2017/080355, filed Nov. 24, 2017, which claims the benefit of Japanese Application No. 2016-229551, filed on Nov. 25, 2016, each of which being incorporated by reference herein.

### FIELD

The present invention relates to a method for producing an open cell rigid polyurethane foam. In particular, the present invention relates to a method for producing an open cell rigid polyurethane foam which allows for quick and easy production of an open cell rigid polyurethane foam which has stably a low density and thermal insulation property regardless of the temperature of raw materials during the reaction, ambient temperature, desired thickness, or the like.

### BACKGROUND

The production of a foamed synthetic resin such as a polyurethane foam by reacting and foaming a polyol and polyisocyanate under the presence of a foam stabilizer, a catalyst, a flame retardant, and a foaming agent, has been widely carried out. In particular, when a rigid polyurethane foam (also referred to as “rigid foam” hereinafter) is produced as a thermal insulation material or the like at a building site or the like, a spraying method is often employed. In the spraying method, two liquids of a polyol-containing component and polyisocyanate are each fed to a chamber in a spray gun, where the two liquids are mixed (collide), then the mixed liquid is sprayed onto a workpiece such as a wall surface and immediately foamed on the wall surface or the like to form a thermal insulation material or the like.

This spraying method has been discussed variously in order to obtain a rigid foam of good quality. For example, JP 2010-168575 A discloses a method for producing an open cell rigid synthetic resin having a density of about 12 to 15 kg/m³, in which water is used as a foaming agent. WO 2013/058341 discloses a method for producing a rigid synthetic resin having a density of about 10 to 13 kg/m³, in which water is used as a foaming agent and a certain polyol is used. JP 2015-4011 A discloses a method for producing a rigid synthetic resin having a density of about 11 to 14 kg/m³, in which water is used as a foaming agent and a certain polyol is used at a certain blending ratio. JP 2010-168575 A, WO 2013/058341 and JP 2015-4011 A describe a method for producing an open cell rigid polyurethane foam which has a low density (less than or equal to 25 kg/m³) and excellent thermal insulation property. However, in the combination therein, the open cell rigid polyurethane can be affected significantly by the ambient temperature and the thickness of the sprayed foam. For example, when the sprayed thickness is large, the reaction accelerates because reaction heat is easily accumulated in the foam. On the other hand, when the thickness is small, the reaction slows down since reaction heat is easily lost. This results in a large variation in the foam density and a wide range of changes in the cell condition and air permeability. Thus, stable performance as a thermal insulation material cannot be obtained. As a countermeasure, for example, the combination is changed in summer time and in winter time.

It has also been discussed variously that an adduct in which carbon dioxide is added to an amine (simply referred to as “adduct” or “amine carbonate salt” hereinafter) is used as a foaming agent. The amine carbonate salt is one of powerful foaming agents because it generally releases carbon dioxide in a short time upon the contact with isocyanate.

JP 62-220512 A discloses a method for producing a polyurethane foam for thermal insulation of a fridge, in which a special amine/carbon dioxide adduct is used. However, this method is not suitable for spraying because the gel time is long and the reactivity is inferior, and thus, it is difficult to produce efficiently an open cell polyurethane foam.

JP 63-295617 A discloses a method for producing a rigid urethane foam for thermal insulation, in which a formate salt or carbonate salt of dimethylaminopropylamine is used for foaming. However, the raw materials in JP 63-295617 A are not fast in the reaction, either.

JP 2000-239339 A discloses a method for producing a closed cell rigid urethane foam for thermal insulation, in which a salt of a certain amine and carbon dioxide is used for foaming. However, the raw materials in JP 2000-239339 A are not fast in the reaction, either.

JP 2001-524995 A discloses a method for producing a rigid urethane foam, in which an adduct of a primary or secondary amine and carbon dioxide is used for foaming. However, in JP 2001-524995 A, the major component of the foaming agent is hydrochlorofluorocarbon which affects global warming, and the foam density is not low.

JP 2014-125490 A discloses a rigid urethane foam in which a carbonate salt of a primary or secondary amine compound and an amine catalyst are used. However, the reactivity is small and the foam density is not low, either.

Under such technical conditions, a demand exists for the creation of a method for producing an open cell rigid polyurethane foam which allows for quick and easy production of a low-density open cell rigid polyurethane foam in which the foam density and thermal insulation property do not easily change due to the ambient temperature or the sprayed thickness.

### SUMMARY

The present invention has an object to provide a method for producing an open cell rigid polyurethane foam which allows for quick and easy production of a low-density open cell rigid polyurethane foam which has a stable foam density and thermal insulation property.

According to the invention, the following is provided:

(1) A production method of an open cell rigid polyurethane foam, comprising foaming a mixed liquid of a polyol-containing component comprising a polyol mixture (a), a catalyst (b) and a foaming agent (c), and a polyisocyanate component (d),
wherein the foaming agent (c) consists of water and an adduct of an amine compound having a primary or secondary amino group(s) and carbon dioxide,
the amount of the water is 10 to 80 parts by mass based on 100 parts by mass of the polyol mixture (a), and
the amount of the adduct is 1 to 20 parts by mass based on 100 parts by mass of the polyol mixture (a).

(2) The production method according to (1), wherein the polyol mixture (a) comprises a polyol (A) and a polyol (B),
the polyol (A) is obtained by subjecting alkylene oxide to ring-opening addition polymerization using an initiator having 2 to 8 functional groups and has a hydroxyl value of 100 to 900 mg KOH/g, and
the polyol (B) is a polyether polyol which is obtained by subjecting alkylene oxide to ring-opening addition polymerization using an initiator having 2 to 4 functional groups which does not contain a nitrogen atom, and which has a hydroxyl value of 10 to 80 mg KOH/g.

(3) The production method according to (1) or (2), wherein the cream time of the mixed liquid of the polyol-containing composition and (d) the polyisocyanate component is less than or equal to 1.5 seconds.

(4) The production method according to any one of (1) to (3), wherein the mixture ratio (volume ratio) of the polyol-containing composition to (d) the polyisocyanate component is 1:1.

(5) The production method according to any one of (1) to (4), wherein the core density of the open cell rigid polyurethane foam is less than or equal to 25 kg/m³.

(6) The production method according to any one of (1) to (5), wherein the thermal conductivity of the open cell rigid polyurethane foam is less than or equal to 40 mW/m·K.

(7) The production method according to any one of (1) to (6), wherein the closed cell ratio of the open cell rigid polyurethane foam is less than or equal to 10%.

(8) The production method according to any one of (1) to (7), wherein the compressive strength of the open cell rigid polyurethane foam is 10 to 40 kPa.

(9) The production method according to any one of (1) to (8), wherein said amine compound having a primary or secondary amino group(s) is at least one selected from an alkylamino compound and an alkanolamine compound.

(10) The production method according to any one of (1) to (9), wherein (c) the catalyst is an amine catalyst.

(11) The production method according to any one of (1) to (10), wherein said polyol-containing component further comprises a flame retardant and a foam stabilizer as desired.

(12) The production method according to any one of (1) to (11), wherein the foaming is carried out by a spraying method.

(13) An open cell rigid polyurethane foam obtained by the production method according to any one of (1) to (12).

(14) A polyol-containing composition for producing an open cell rigid polyurethane foam with (d) a polyisocyanate component, the composition comprising a polyol mixture (a), a catalyst (b), and a foaming agent (c),
wherein the foaming agent (c) consists of water and an adduct of a primary or secondary amine compound and carbon dioxide,
the amount of water is 10 to 80 parts by mass based on 100 parts by mass of the polyol mixture (a), and
the amount of the adduct is 1 to 20 parts by mass based on 100 parts by mass of the polyol mixture (a).

(15) The polyol-containing composition according to (14),

wherein the polyol mixture (a) comprises a polyol (A) and a polyol (B),

the polyol (A) is obtained by subjecting alkylene oxide to ring-opening addition polymerization using an initiator having 2 to 8 functional groups and has a hydroxyl value of 100 to 900 mg KOH/g, and

the polyol (B) is a polyether polyol which is obtained by subjecting alkylene oxide to ring-opening addition polymerization using an initiator having 2 to 4 functional groups which does not contain a nitrogen atom, and which has a hydroxyl value of 10 to 80 mg KOH/g.

### DETAILED DESCRIPTION

According to the present invention, a low-density open cell rigid polyurethane foam which has a stable foam density and thermal insulation property can be quickly and easily produced. The polyol-containing composition of the invention has an excellent initial foaming property when mixed with an isocyanate component, and this reaction is not easily affected by changes in the conditions during the foaming such as the thickness of the open cell rigid polyurethane foam, the ambient temperature and the mixed liquid temperature. Therefore, the polyol-containing composition of the invention is advantageous when a low-density open cell rigid polyurethane foam having stable thermal insulation property is produced stably and quickly. In addition to its low density, the open cell rigid polyurethane foam of the invention also exhibits good performance in terms of contractile property. Thus, the open cell rigid polyurethane foam obtained by the production method according to the invention is advantageous especially in the application for construction and building materials because the open cell rigid polyurethane foam is lightweight and provides a satisfying performance as a thermal insulation material and exhibits excellent forming workability and hygiene in the working environment.

The method for producing an open cell rigid polyurethane foam according to the invention comprises foaming a mixed liquid of a polyol-containing composition comprising a polyol mixture (a), a catalyst (b) and a foaming agent (c), and (d) a polyisocyanate component, wherein the foaming agent (c) consists of water and an adduct of a primary or secondary amine compound and carbon dioxide, the amount of the water is 10 to 80 parts by mass based on 100 parts by mass of the polyol mixture (a), and the amount of the adduct is 1 to 20 parts by mass based on 100 parts by mass of the polyol mixture (a).

The details will be described as follows.

[Polyol-Containing Composition]

The polyol-containing composition according to the invention comprises a polyol mixture (a), a catalyst (b), and a foaming agent (c). The polyol-containing composition is used as a raw material for producing an open cell rigid polyurethane foam in order to be mixed with an isocyanate component for foaming.

[Polyol Mixture (a)]

The polyol mixture (a) comprises a plurality of polyols and preferably comprises at least a polyol (A) and a polyol (B) which will be described later. In a preferred embodiment, the polyol mixture (a) only consists of the polyol (A) and the polyol (B).

The content of the polyol mixture (a) in the polyol-containing composition according to the invention is, in terms of efficient production of an open cell rigid polyurethane foam, preferably 30 to 90 parts by mass, more preferably 40 to 80 parts by mass, and further preferably 50 to 70 parts by mass.

[Polyol (A)]

The polyol (A) is a polyol which is obtained by subjecting alkylene oxide to ring-opening addition polymerization using an initiator having 2 to 8 functional groups, and which has a hydroxyl value of 100 to 900 mg KOH/g. For the polyol (A), one kind or a mixture of several kinds can be used.

The polyol (A) can be produced according to a method known in the art, using an initiator having 2 to 8 functional groups, a polymerization catalyst, and alkylene oxide. Examples of initiators to be used for the production of the polyol (A) include polyalcohols, aromatic amine compounds, aliphatic amine compounds, and mannich compounds.

Examples of polymerization catalysts to be used for the production of the polyol (A) include alkaline metal catalysts, cesium catalysts, phosphate catalysts, and composite metal cyanide complex catalysts (DMC catalysts).

Suitable examples of alkylene oxide to be used for the production of the polyol (A) include propylene oxide and ethylene oxide. Therefore, alkylene oxide is preferably a combination of ethylene oxide and propylene oxide. The ratio of ethylene oxide to the total amount of alkylene oxide is 0 to 80% by mass, preferably 0% by mass to 50% by mass, and further preferably 5 to 50% by mass. When ethylene oxide is used, a majority of hydroxyl groups in the polyol (A) are primary hydroxyl groups, and the reactivity of the polyol (A) increases and thus the polyol (A) is more reactive with isocyanate. Therefore, the use of ethylene oxide is preferred in the application for spraying.

In addition, the ratio of ethylene oxide within the above range is preferred in preventing an open cell foam from contracting. The ratio of ethylene oxide within the above range is also advantageous because the compatibility of the polyol (A) and water used as a foaming agent is improved, and good miscibility with an isocyanate component and the like is provided, and furthermore, the appearance and mechanical characteristics of an open cell rigid polyurethane foam are improved.

The hydroxyl value of the polyol (A) is, as described above, 100 to 900 mg KOH/g, preferably 200 to 800 mg KOH/g and more preferably 200 to 500 mg KOH/g. The hydroxyl value used in the context of the present invention means the number of milligrams of potassium hydroxide required to acetylate hydroxyl groups contained in one gram of a sample (solid content). Acetic anhydride is used for the acetylation of hydroxyl groups in the sample, and after unused acetic acid is titrated by a potassium hydroxide solution, the hydroxyl value is calculated according to the following equation.

Hydroxyl value [mg KOH/g]=[((A−B)×f×28.05)/S]+acid value

A: the amount (ml) of 0.5 mol/l potassium hydroxide solution in ethanol used in the blank test

B: the amount (ml) of 0.5 mol/l potassium hydroxide solution in ethanol used in the titration

f: factor

S: the sampling weight (g)

One particular example of the polyol (A) is a polyether polyol (mannich polyol) which is obtained by subjecting alkylene oxide to ring-opening addition polymerization of a mannich compound obtained by reacting a phenol, an aldehyde, and an alkanolamine.

The mannich compound described above is obtained by reacting a phenol, an aldehyde, and an alkanolamine. Examples of phenols herein include phenols, nonylphenols, cresols, bisphenol A, and resorcinol, and in terms of the improvement of the compatibility of the polyol and isocyanate and the promotion of the cell appearance, nonylphenols are preferred. Examples of aldehydes include formaldehyde and paraformaldehyde, and formaldehyde is preferred in terms of the improvement of adhesive property of the foam. Examples of alkanolamines include monoethanolamine, diethanolamine, triethanolamine, 1-amino-2-propanol, and aminoethylethanolamine, and diethanolamine is preferred in terms of a good balance between the improvement of the foam strength and the reduction of the polyol viscosity.

The ratio of raw materials in obtaining a mannich compound is preferably 1.5 to 2.0 mol of an aldehyde and 2.3 to 3.0 mol of an alkanolamine based on 1 mol of a phenol. The ratio of an aldehyde to a phenol within the above range is advantageous in suppressing the occurrence of odor during the production of an open cell rigid polyurethane foam and providing the foam with adhesive property. The ratio of an alkanolamine to an aldehyde within the above range is advantageous in suppressing the occurrence of odor during the production of an open cell rigid polyurethane foam and limiting the foam contractile property at a low level.

Furthermore, another suitable example of the polyol (A) is an aromatic amine polyol. The aromatic amine polyol is a polyether polyol which is obtained by subjecting alkylene oxide to ring-opening addition polymerization of an aromatic amine compound as an initiator.

Examples of the above aromatic amine compounds include diphenylmethanediamine, tolylenediamine, and xylenediamine, and diphenylmethane diamine and tolylenediamine are preferred in terms of the improvement of combustion property and thermal conductivity of polyurethane.

Another suitable example of the polyol (A) is an aliphatic amine polyol. The aliphatic amine polyol is a polyether polyol which is obtained by subjecting alkylene oxide to ring-opening addition polymerization of an aliphatic amine compound as an initiator.

Examples of the above aliphatic amine compounds include, for example, alkanolamines such as monoethanolamine, diethanolamine, and triethanolamine; and alkylamines such as ethylenediamine, propylenediamine, and 1,6-hexanediamine, and ethylenediamine, monoethanolamine and diethanolamine are preferred.

Yet another suitable example of the polyol (A) is a polyol in which a polyalcohol having 2 to 8 functional groups is used as an initiator. The polyalcohol as an initiator is preferably an alcohol having 2 to 6 functional groups. Particular examples of polyalcohols include ethylene glycol, propylene glycol, glycerin, trimethylolpropane, diethylene glycol, diglycerin, pentaerythritol, sorbitol, and sucrose. One kind of initiator can be used, or two or more kinds can be used in combination.

The content of the polyol (A) is preferably 10 to 80 parts by mass, and more preferably 15 to 70 parts by mass based on 100 parts by mass of the polyol mixture (a). The ratio of the polyol (A) of less than or equal to 80 parts by mass is effective in preventing a high closed cell ratio and thus preventing a foam from easily contracting. The ratio is also effective in preventing the extension of operation time due to the excessive hardening of the foam surface which causes a difficulty in cutting the foam with a wavy knife or the like during an operation at a working site. Furthermore, the ratio of the polyol (A) of more than or equal to 10 parts by mass is effective in preventing the decrease of flame resisting property.

[Polyol (B)]

The polyol (B) is a polyether polyol which is obtained by subjecting alkylene oxide to ring-opening addition polymerization using an initiator having 2 to 4 functional groups which does not contain a nitrogen atom, and which has a hydroxyl value of 10 to 80 mg KOH/g. For the polyol (B), one kind or a mixture of several kinds can be used.

The polyol (B) can be produced according to a method known in the art, using an initiator having 2 to 4 functional groups which does not contain a nitrogen atom, a polymerization catalyst, and alkylene oxide. Examples of polymerization catalysts to be used for the production of the polyol (B) include the same catalysts as described for the polyol (A).

The initiator to be used for the production of the polyol (B) is preferably a polyalcohol having 2 to 4 functional groups. Particular examples thereof include ethylene glycol, propylene glycol, glycerin, trimethylolpropane, diethylene glycol, diglycerin, and pentaerythritol. One kind of initiator can be used or several kinds can be combined.

Examples of alkylene oxide to be used for the production of the polyol (B) include propylene oxide and ethylene oxide. Therefore, alkylene oxide is preferably a combination of ethylene oxide and propylene oxide. The ratio of ethylene oxide to the total amount of alkylene oxide is 0 to 80% by mass, and preferably 5% by mass to 50% by mass.

The hydroxyl value of the polyol (B) is, as described above, 10 to 80 mg KOH/g, preferably 20 to 70 mg KOH/g and more preferably 20 to 40 mg KOH/g.

The content of the polyol (B) is preferably 10 to 70 parts by mass, more preferably 20 to 60 parts by mass, and further preferably 30 to 50 parts by mass based on 100 parts by mass of the polyol mixture (a). The amount of the polyol (B) within the above range can provide the cell structure of the resulting rigid foam with appropriate connection property and does not ruin other properties such as flame resisting property. If the amount of the polyol (B) is below this range, cells tend to be closed and a problem such as contraction occurs. If the amount is above this range, the degree of cross-linking and reaction rate decrease, and foams sinks in after degassing (what is called back shot). As a result, the decrease in hardness and roughening of cells easily occur, and the combustion property decreases.

[Other Polyols]

The polyol mixture (a) may contain another polyol other than polyols (A) and (B). For example, the polyol mixture (a) can further contain a polyphenol or an aminated polyol. The content of another polyol may be, for example, less than or equal to 20 parts by mass, and more particularly 0.1 to 15 parts by mass based on 100 parts by mass of the polyol mixture (a).

[Catalyst (b)]

In the polyol-containing composition according to the invention, the catalyst (b) may be composed of one kind or used in combination of several kinds. Examples of catalysts (b) include amine catalysts, lead catalysts and bismuth catalysts, and a non-volatile, reactive amine catalyst is preferably used.

Non-volatile amine catalysts are preferred because health problems when spraying the formulation, such as rainbow eye (blurred vision), toxicity and deterioration of forming property can be avoided.

According to the invention, for an amine catalyst, a reactive amine catalyst with more foaming activity is preferred, and particular examples thereof include isocyanate-reactive catalysts. Accordingly, the catalyst (b) according to the invention preferably comprises an isocyanate-reactive catalyst. The isocyanate-reactive catalyst herein means a reactive amine catalyst which has one or more isocyanate-reactive active hydrogen groups in the molecule. The usage of an isocyanate-reactive catalyst is advantageous in improving the quality of open cell property of the foam, decreasing the density, and improving workability during spray foaming (the amount of sprayed thickness and dripping property).

Particular and suitable examples of isocyanate-reactive catalysts include N,N,N′-trimethyaminoethylethanolamine, dimethylaminoethoxyethanol, and N,N,N′-trimethyl-N′-hydroxyethyl-bisaminoethylether.

In the polyol-containing composition, the content of the catalyst (b) may be changed as appropriate depending on the kind, nature and the like of the polyol (a) and the polyisocyanate component (d), but the content of the catalyst (b) is preferably 3 to 15 parts by mass based on 100 parts by mass of the polyol mixture.

[Foaming Agent (c)]

The foaming agent consists of water and an adduct of an amine compound having a primary or secondary amino group(s) and carbon dioxide.

Suitable examples of amine compounds having a primary or secondary amino group(s) include alkylamine compounds such as buthylamine, ethylenediamine, hexamethylenediamine, diethylenetriamine, triethylenetetramine, and dimethylaminopropylamine, alkanolamine compounds such as ethanolamine, N-methylethanolamine, diethanolamine, isopropanolamine, and diisopropanolamine, and hydroxylamine.

In order to obtain a sufficient function as a foaming agent, the molar ratio of the amine compound to carbon dioxide is preferably 0.3 to 1.0 mol, and more preferably 0.4 to 1.0 mol based on 1 mol of the amino group. For a primary to secondary amine compound having two or more amino groups, carbon dioxide is also preferably 0.3 to 1.0 mol based on 1 mol of the amino groups.

In the polyol-containing composition of the invention, the content of the adduct of an amine compound having a primary or secondary amino group(s) and carbon dioxide is 1 to 20 parts by mass, preferably 3 to 15 parts by mass, and further preferably 4 to 12 parts by mass based on 100 parts by mass of the polyol mixture (a). The content of the above adduct of more than or equal to 1 part by mass is preferred because the decrease of the initial foaming property of an open cell polyurethane foam is prevented, and furthermore, a good cell condition and thermal conductivity are maintained when the thickness of the sprayed foam is as thin as about 45 mm. In addition, the content of the above adduct of less than or equal to 20 parts by mass is preferred because the amount used of the amine compound is at a low level and thus the manufacturing cost of the foam is suppressed.

The adduct of an amine compound having a primary or secondary amino group(s) and carbon dioxide can be suitably manufactured, for example, by dissolving an amine compound in a solution (preferably water) and further dissolving carbon dioxide in the solution by means of gas introduction. Since the resulting adduct tends to solidify at room temperature, in order to prevent the solidification, the solvent of the solution in which the amine compound is dissolved is preferably a polyol such as liquid glycol, water or a mixture thereof.

In a polyol-containing composition, the content of the adduct of an amine compound having a primary or secondary amino group(s) and carbon dioxide is, as described above, 1 to 20 parts by mass, preferably 3 to 15 parts by mass, and more preferably 4 to 12 parts by mass based on 100 parts by mass of the polyol mixture. As explained earlier, the adduct of an amine compound having a primary or secondary amino group(s) and carbon dioxide can release carbon dioxide in a short time upon the contact with an polyisocyanate component. Moreover, after the release of carbon dioxide, the amine compound can act as a cross-linking agent that reacts with the polyisocyanate component to produce (poly)urea.

The content of water as a foaming agent is, as described above, 10 to 80 parts by mass, preferably 12 to 70 parts by mass, and more preferably 15 to 50 parts by mass based on 100 parts by mass of the polyol mixture (a). The water content of more than or equal to 10 parts by mass is preferred in order to obtain a lightweight foam. Furthermore, the water content of less than or equal to 80 parts by mass is preferred in order to maintain good storage stability of the polyol-containing composition. For the foaming agent of the invention, it is also advantageous to adjust the ratio of water within the above range in order to adjust the density of a rigid polyurethane foam which will be described later within a suitable range.

[Foam Stabilizer]

The polyol-containing composition of the invention may contain a foam stabilizer as desired in terms of the formation of good cells in an open cell rigid polyurethane foam. Examples of foam stabilizers include silicone foam stabilizers and fluorine compound-containing foam stabilizers. Examples of commercially available foam stabilizers include Tegostab® B8002 and Tegostab® B4900 manufactured by Evonik Japan Co., Ltd. One kind of foam stabilizer can be used or several kinds can be used in combination.

In the polyol-containing composition, the content of the foam stabilizer may be selected as appropriate, but preferably 0.1 to 10 parts by mass based on 100 parts by mass of the polyol mixture (a).

[Flame Retardant]

The polyol-containing composition of the invention may contain a flame retardant as desired in terms of the assurance of safety. A flame retardant is preferably a phosphorus flame retardant, and suitable examples thereof include tricresyl phosphate (TCP), triethyl phosphate (TEP), tris(s-chloroethyl)phosphate (TCEP) and tris(β-chloropropyl)phosphate (TCPP). One kind of flame retardant can be used or several kinds can be used in combination.

In the polyol-containing composition, the content of the flame retardant may be selected as appropriate, but preferably 10 to 80 parts by mass, and more preferably 20 to 60 parts by mass based on 100 parts by mass of the polyol mixture (a). The flame retardant content of more than or equal to the lower limit of the above range is preferred in improving the flame resisting property of the foam. Furthermore, the flame retardant content of less than or equal to the upper limit of the above range is advantageous in maintaining the compressive strength of the rigid foam.

[Polyisocyanate Component (d)]

In the production method according to the invention, as described above, an isocyanate component (d) is used as a raw material for producing an open cell rigid polyurethane foam.

Suitable examples of the polyisocyanate components according to the invention include aromatic polyisocyanate, alicyclic polyisocyanate and aliphatic polyisocyanate, which have two or more isocyanate groups. Particular examples of the polyisocyanate components include polyisocyanate such as tolylene diisocyanate (TDI), diphenylmethane diisocyanate (MDI), polymethylenephenyl isocyanate (commonly known as: polymeric MDI), xylylene diisocyanate (XDI), isophorone diisocyanate (IPDI) or hexamethylene diisocyanate (HMDI) or prepolymer-modified products thereof, isocyanurate-modified products thereof, urea-modified products thereof, and carbodiimide-modified products thereof, and polymeric MDI is preferred. For the above polyisocyanate component, one kind can be used or several kinds can be used at the same time.

The viscosity of the polyisocyanate component (d) at 25° C. is preferably 50 to 400 mPa·s. It is preferred to set the viscosity of the polyisocyanate component (d) within the above range in order to maintain good miscibility during the spraying operation according to a spraying method and avoid the poor appearance of an open cell rigid polyurethane foam.

The amount used of the polyisocyanate component (d) is preferably such an amount that the blending ratio of the polyol-containing composition to the polyisocyanate component (d) is preferably 30 to 100, and more preferably 45 to 65 in the isocyanate index. The isocyanate index herein is expressed as [(the equivalent amount of isocyanate groups in the polyisocyanate component)/(the equivalent amount of active hydrogen in the polyol-containing composition)×100]. The amount used of the polyisocyanate component (d) within the above range is preferred in order to prevent inadequate hardness and a contraction problem of a rigid polyurethane foam and maintain a good density and reactivity.

[Mixing]

In the production method according to the invention, the above polyol-containing composition and polyisocyanate component (d) are combined to form a mixed liquid.

The mixture ratio (volume ratio) of the polyol-containing composition to the polyisocyanate component (d) is not particularly limited as long as the effects of the invention are not impaired, but preferably 1:0.5 to 1:2, more preferably 1:0.8 to 1:1.2, and further preferably 1:0.9 to 1:1.1, and yet further preferably 1:1.

In the production method according to the invention, the mixed liquid mentioned above may contain a solid content as long as the effects of the invention are not impaired, but in terms of the efficient formation of a foam, the constitution only in a liquid form is preferred. The cream time and rise time of the above mixed liquid of the invention is preferably a short period of time in terms of a quick formation of a rigid polyurethane foam. The cream time herein means a time to the occurrence of foaming in the mixed liquid provided that the time when the polyol-containing composition and the polyisocyanate component (d) start to be mixed is set at zero second. The rise time means a time to the completion of foaming in the above mixed liquid (a time it takes before the rise of the foam surface due to the foaming stops). In the present invention, the cream time and the rise time are, as described later in Examples, identified by an average value of the time measurements determined visually by the stirring of trained specialized panelists (10 panelists).

The cream time of the above mixed liquid is preferably less than or equal to 2.0 seconds, more preferably less than or equal to 1.8 seconds, and further preferably less than or equal to 1.5 seconds. The lower limit of the cream time can be, for example, more than or equal to 0.5 seconds, but not particularly limited thereto.

The rise time of the above mixed liquid is preferably less than or equal to 10 seconds, more preferably 4 to 10 seconds, and further preferably 5 to 8 seconds.

In the production method according to the invention, the above mixed liquid can be mixed with an optional additive other than the polyol-containing composition and the polyisocyanate component (d) as long as the effects of the invention are not inhibited. Examples of additives include fillers such as calcium carbonate and barium sulfate, antioxidants, anti-aging agents such as ultraviolet absorbers, plasticizers, coloring agents, anti-fungal agents, foam breakers, dispersing agents, ant repelling agents, and discoloration inhibitors. Moreover, as long as the effects of the invention are not impaired, a physical foaming agent (such as Freon) may be added to the above mixed liquid as an additive, and such an aspect can be also included in the invention. Such an additive may be added to either the polyol-containing composition or the polyisocyanate component (d) before mixing, but is preferably contained in the polyol-containing composition.

The mixing of the above polyol-containing composition and the polyisocyanate component (d) is not particularly limited and can be carried out integrally with foaming, using a known apparatus described in a foaming method as described later.

[Foaming Step]

In the production method according to the invention, a mixed liquid of the above polyol-containing composition and polyisocyanate component (d) is foamed to obtain an open cell rigid polyurethane foam. The foaming method is not particularly limited, but examples thereof includes stirring, collision and shaking, and stirring and collision are preferred.

[Spray Foaming]

According to a particularly preferred aspect of the invention, the foaming method in the invention is spray foaming (spraying method). Spray foaming herein means a foaming method in which a polyol blend and a polyisocyanate compound are mixed and reacted while being sprayed. Spray foaming is advantageous in that mixing and foaming of the polyol-containing composition and the polyisocyanate component (d) can be carried out integrally and quickly. Spray foaming is preferably employed in order to, for example, apply a rigid polyurethane foam as a thermal insulation material at a building site or a construction site and tightly arrange the foam on a bumpy portion. In particular, depending on the selection of a catalyst or the like, it is possible to employ spray foaming and complete the operation especially quickly. It is advantageous to employ such spray foaming at a building site or a construction site in terms of the decrease of the construction cost and the improvement of workability. Particular aspects of spray foaming are not particularly limited, but an air spraying method is preferred in which a polyol blend and a polyisocyanate compound are mixed by a mixing head and foamed,

In the above spray foaming, the thickness of sprayed open cell rigid polyurethane foam may be appropriately set depending on the structure of the object to be sprayed and the usage application of the foam, but can be 5 mm to 150 mm, and preferably 45 mm to 100 mm, for example.

[Open Cell Rigid Polyurethane Foam]

A rigid polyurethane foam produced by the production method according to the invention is, as described above, an open cell rigid polyurethane foam. The “open cell” of a polyurethane foam in the invention does not mean that all of the cells (air bubbles) contained in the polyurethane foam are connected, but means instead that at least one portion thereof is connected and thus, closed cells may be present in the polyurethane foam. In the present invention, it is possible to adjust air permeability of the rigid polyurethane foam obtained in the invention by controlling as appropriate the ratio of open cells and closed cells in the polyurethane foam. Thus, according to a preferred aspect of the invention, open cells and closed cells are mixed in the open cell rigid polyurethane foam. The “rigid polyurethane foam” means a spray-applied rigid urethane foam for thermal insulation of buildings provided by JIS 9526 (2015).

According to the production method of the invention, for the open cell rigid polyurethane foam, parameters such as application at a building or construction site and uniformity of materials as well as, in terms of the assurance of lightweight property, closed cell ratio, average diameter of cell diameters (the average of longest diameters among diameters that connect the edge of a cell with the other edge of the cell), cell diameter distribution, dripping property, contractile property, core density (corresponding to the apparent core density described in JIS K7222 (2005)), thermal conductivity, and hardness can be adjusted. The closed cell ratio, the average diameter of cell diameters, the cell diameter distribution, the dripping property, the contractile property, the core density and the thermal conductivity are measured and determined according to methods described later in Examples.

In the open cell rigid polyurethane foam of the invention, the closed cell ratio is preferably less than or equal to 15%, and more preferably less than or equal to 10%.

In the open cell rigid polyurethane foam of the invention, the average diameter of cell diameters is preferably 100 to 400 μm, more preferably 120 to 400 μm, further preferably 140 to 320 μm, and yet further preferably 150 to 300 μm. It is advantageous to set the average diameter of cell diameters within the above range in order to prevent the deterioration of the thermal conductivity due to the excessively strong tendency of open cells and ensure the dimension stability of materials. The above average diameter of cell diameters may be determined using any cell diameters which are either parallel or perpendicular with regard to the foaming direction. The average diameter of cell diameters is determined according to a method described later in Examples.

The cell diameter distribution in the open cell rigid polyurethane foam of the invention is preferably 100 to 500 μm, and more preferably 100 to 450 μm. The distribution width thereof (the upper limit to lower limit of the distribution) is preferably less than or equal to 400 μm, and more preferably less than or equal to 300 μm. The distribution width of cell diameters within the above range is advantageous in order to prevent the deterioration of the thermal conductivity due to the excessively strong tendency of open cells. Furthermore, the adjustment of the average cell diameter and the distribution in the range as described above is preferred in ensuring the dimension stability of materials.

For the dripping property of the open cell rigid polyurethane foam of the invention, the maximum longitudinal width is preferably less than or equal to 2 times the maximum horizontal width of the formed foam, and the maximum longitudinal width is further preferably less than or equal to 1.5 times the maximum horizontal width.

In the open cell rigid polyurethane foam of the invention, contractile property one day after the production of the polyurethane foam is, according to an evaluation method of contractile property which is described later, preferably less than or equal to 5 mm, more preferably less than or equal to 4 mm, and further preferably less than or equal to 3 mm.

The core density of the open cell rigid polyurethane foam of the invention is preferably 7 to 25 kg/m³, and more preferably 10 to 20 kg/m³. The adjustment of the core density of the above rigid polyurethane foam within the above range is preferred in terms of the reduction in weight of materials. In particular, the above core density of more than or equal to 7 kg/m³ is advantageous in maintaining good thermal conductivity. Furthermore, the core density of the above rigid polyurethane foam of less than or equal to 25 kg/m³ is preferred in terms of the material cost.

The thermal conductivity (unit: mW/m·K (23° C.)) of the open cell rigid polyurethane foam of the invention is preferably less than or equal to 50, and more preferably less than or equal to 40.

The measured hardness of the open cell rigid polyurethane foam of the invention by means of the Asker Durometer Type F is preferably 70 to 95, and more preferably 80 to 90 in terms of the use as a building material. In the open cell rigid polyurethane foam of the invention, the compressive strength as measured according to JIS K 7220 is preferably 10 to 40 (kPa), and more preferably 15 to 30 (kPa).

In the present invention, the application of the open cell rigid polyurethane foam of the invention is not particularly limited, but the open cell rigid polyurethane foam is preferably used as a thermal insulation material or a building material. Therefore, according to the present preferred aspect, a thermal insulation material or a building material comprising an open cell rigid polyurethane foam of the invention is provided.

According to another aspect, the use of an open cell rigid polyurethane foam of the invention in the production of a thermal insulation material or a building material is provided. Moreover, according to another aspect, the use of an open cell rigid polyurethane foam of the invention as a thermal insulation material or a building material is provided.

The open cell rigid polyurethane foam of the invention can be, as described above, produced by using a polyol-containing composition along with a polyisocyanate component (d) as raw materials. Therefore, according to another aspect of the invention, a polyol-containing composition is provided which comprises a polyol mixture (a), a catalyst (b), and a foaming agent (c) and which is combined with a polyisocyanate component (d) to produce an open cell rigid polyurethane foam, wherein the foaming agent (c) consists of water and an adduct of an amine compound having a primary or secondary amino group(s) and carbon dioxide, the amount of the water is 10 to 80 parts by mass based on 100 parts by mass of the polyol mixture (a), and the amount of the adduct is 1 to 20 parts by mass based on 100 parts by mass of the polyol mixture (a). According to another aspect described above, the polyol mixture (a) comprises a polyol (A) and a polyol (B), wherein the polyol (A) is a polyol which is obtained by subjecting alkylene oxide to ring-opening addition polymerization using an initiator having 2 to 8 functional groups, and which has a hydroxyl value of 100 to 900 mg KOH/g, and the polyol (B) is a polyether polyol which is obtained by subjecting alkylene oxide to ring-opening addition polymerization using an initiator having 2 to 4 functional groups which does not contain a nitrogen atom, and which has a hydroxyl value of 10 to 80 mg KOH/g. According to yet another aspect, the use of the above polyol-containing composition in the production of an open cell rigid polyurethane foam is provided. It is possible for the person skilled in the art to produce and use the polyol-containing composition according to the above aspect by following the description in the production method according to the invention.

### EXAMPLES

The invention will be explained in detail by way of Examples, but the invention is not limited to these Examples. Unless otherwise specified in particular, the units and measurement methods in the invention follow the prescription of Japanese Industrial Standards (JIS). “Part(s)” and “%” mean “part(s) by mass” and “% by mass” respectively.

[Raw Materials]

Raw materials used in Examples and Comparison Example are as follows. The hydroxyl value of raw materials was measured according to JIS K 1557-1 (2007) and the viscosity was measured according to JIS K 1557-5 (2007).

[Polyols]

Polyol A1: nonylphenol (1 mol), formaldehyde (1.6 mol) and diethanolamine (2.4 mol) were reacted to obtain a mannich compound 1. Propylene oxide (PO) (128 parts by mass) and ethylene oxide (EO) (200 parts by mass) were subjected in this order to ring-opening addition polymerization of this mannich compound 1 (273 parts by mass) to obtain a mannich polyol (polyol A1) having a viscosity of 800 mPa·s at 25° C. and a hydroxyl value of 300 mg KOH/g. The ratio of EO to the total amount of PO and EO was 61% by mass.

Polyol A2: glycerin (125 parts by mass) was used as an initiator, and only propylene oxide (875 parts by mass) was subjected to ring-opening addition polymerization to obtain a polyether polyol having a viscosity of 250 mPa·s at 25° C. and a hydroxyl value of 235 mg KOH/g.

Polyol A3: a mixed liquid of sucrose, propylene glycol and water (mass ratio—sucrose:propylene glycol:water=90:5.7:4.3) (284 parts by mass in total) was used as an initiator, and only propylene oxide (716 parts by mass) was subjected to ring-opening addition polymerization to obtain a polyether polyol having a viscosity of 12,000 mPa·s at 25° C. and a hydroxyl value of 380 mg KOH/g.

Polyol B1: glycerin (99 parts by mass) was used as an initiator, and propylene oxide (PO) (699 parts by mass) and ethylene oxide (EO) (202 parts by mass) were subjected to ring-opening addition polymerization in this order to obtain a polyether polyol having a viscosity of 1,150 mPa·s at 25° C. and a hydroxyl value of 28 mg KOH/g. The ratio of EO to the total amount of PO and EO was 22% by mass.

[Foaming Agents]

Water and an adduct of a primary or secondary amine compound and carbon dioxide (amine carbonate salt) as described below were produced as a foaming agent.

Amine Carbonate Salt 1: (an Adduct of a Primary Amine Compound and Carbon Dioxide)

To a 10-liter pressure resisting reaction vessel with a rotor blade, 3,750 g of dimethylaminopropylamine and 1,138 g of water were introduced and stirred. A carbon dioxide tank with a pressure reducing valve was connected to this reaction vessel, and carbon dioxide with its pressure reduced to 2 atmospheres was supplied to a liquid portion while stirring. The liquid temperature rose to 90° C. within about 10 minutes and then slowly lowered. The liquid was taken out from the vessel 8 hours after the carbon dioxide started to be supplied and measured to be 6,500 g. This reaction liquid kept in a liquid form at room temperature, and even when the liquid was heated to 80° C., abnormal occurrence of carbon dioxide was not observed, and this reaction liquid was used as a foaming agent. The calculated value of the addition amount of this carbon dioxide was 1,612 g, which matched the found value obtained by separating carbon dioxide from the resulting foaming agent with phosphoric acid and measuring the mass change. (The mass ratio of each composition in this reaction liquid is dimethylaminopropylamine/carbon dioxide/water=57.7%/24.8%/17.5%. Therefore, the content of the amine carbonate salt in this reaction liquid and the content of water were 82.5% by mass and 17.5% by mass respectively, and based on this content ratio, the polyol-containing composition was adjusted.)

Amine Carbonate Salt 2: (an Adduct of a Secondary Amine Compound and Carbon Dioxide)

To a 10-liter pressure resisting reaction vessel with a rotor blade, 3,942 g of N-methylethanolamine and 900 g of water were introduced and stirred. A carbon dioxide tank with a pressure reducing valve was connected to this reaction vessel, and carbon dioxide with its pressure reduced to 2 atmospheres was supplied to a liquid portion while stirring. The liquid temperature rose to about 90° C. within about 3 hours, and then slowly lowered. The reaction liquid was taken out from the reaction vessel 8 hours after the carbon dioxide started to be supplied and measured to be 5,880 g. This reaction liquid kept in a liquid form at room temperature, and even when the liquid was heated to 80° C., abnormal occurrence of carbon dioxide was not observed, and this reaction liquid was used as a foaming agent. The calculated value of the addition amount of carbon dioxide was 1,038 g, which matched the found value obtained by separating carbon dioxide from the resulting foaming agent with phosphoric acid and measuring the mass change. (The weight ratio of each composition in this reaction liquid is N-methylethanolamine/carbon dioxide/water=67.0%/17.7%/15.3%. Therefore, the content of the amine carbonate salt in this reaction liquid and the content of water were 84.7% by weight and 15.3% by weight respectively, and based on this content ratio, the polyol-containing composition was adjusted.)

[Catalysts]

Catalyst 1: N,N,N′-trimethyaminoethylethanolamine (Dabco® T, produced by Air Products and Chemicals, Inc.)

Catalyst 2: dimethylaminoethoxyethanol (Polycat® 37, produced by Air Products and Chemicals, Inc.)

Catalyst 3: N,N,N′-trimethyl-N′-hydroxyethyl-bisaminoethylether (JEFFCAT® ZF-10, produced by Huntsman Corporation)

[Foam Stabilizers]

Foam stabilizer 1: silicone foam stabilizer (Tegostab® B8002, produced by Evonik Japan Co., Ltd.)

Foam stabilizer 2: silicone foam stabilizer (SZ-1718, produced by Dow Corning Toray Co., Ltd.)

[Flame Retardant]

Flame retardant 1: tris(2-chloropropyl)phosphate (TMCPP, produced by DAIHACHI CHEMICAL INDUSTRY CO., LTD.)

[Isocyanate Compound]

Polymeric MDI (Sumidur 44V20L, produced by Sumika Covestro Urethane Co., Ltd., viscosity (25° C.) 180 mPa s, NCO content ratio: 31.5%)

### Test Example 1

(Production of a Rigid Polyurethane Foam)

A rigid foam was produced according to JIS A 9526 (Examples 1 to 3 and Comparison Example 1) in a method in which a mixed liquid of a polyol-containing composition and a polyisocyanate component (d) as described in Table 1 (polyol-containing composition:polyisocyanate component (d)=1:1 (volume ratio)) was sprayed using a spray foam device onto a plyboard which was assumed to be a wall surface and arranged vertically. The details of each condition such as a spray condition and sprayed thickness are described later in Table 2. For the spray foam device, the reactor E-20 produced by Graco Inc. was used, and a fusion spray gun produced by Graco Inc. (chamber size 4242) was used as a spraying gun. The output rate was 50 g per second, the set output pressure was 6.0 MPa, and the air pressure was 0.6 MPa.

TABLE 1

| | | Exam- | Exam- | Exam- | Comparison |
|---|---|---|---|---|---|
| | | ple 1 | ple 2 | ple 3 | Example 1 |
| Polyol- | Polyol A1 | 20.0 | 20.0 | 20.0 | 20.0 |
| containing | Polyol B1 | 30.0 | 30.0 | 30.0 | 30.0 |
| composition | Polyol A2 | 20.0 | 20.0 | 20.0 | 20.0 |
| | Polyol A3 | 30.0 | 30.0 | 30.0 | 30.0 |
| | Water | 16.8 | 16.8 | 16.8 | 18.0 |
| | Amine | 4.0 | — | 10.0 | — |
| | carbonate | | | | |
| | salt 1 | | | | |
| | Amine | — | 4.0 | — | — |
| | carbonate | | | | |
| | salt 2 | | | | |
| | Catalyst 1 | 5.5 | 5.5 | 2.5 | 5.5 |
| | Catalyst 2 | 5.5 | 5.5 | 2.5 | 5.5 |
| | Catalyst 3 | — | — | — | 3.3 |
| | Flame | 40.0 | 40.0 | 40.0 | 40.0 |
| | retardant 1 | | | | |
| | Foam | 2.0 | 2.0 | 2.0 | 2.0 |
| | stabilizer 1 | | | | |
| | Foam | 0.5 | 0.5 | 0.5 | 0.5 |
| | stabilizer 2 | | | | |

| | | | | |
|---|---|---|---|---|
| Total parts by mass | 174.3 | 174.3 | 174.3 | 174.8 |

[Evaluation Method]

Each evaluation was carried out according to the following methods. For the evaluation of the presence or absence of contraction, cell condition, core density, and thermal conductivity, the thickness of the sprayed foam was 45 mm or 100 mm.

[Creaming Time/Rise Time]

A piece of paper was placed on the floor, and using the above-described spray foam device and gun, a polyol-containing composition and a polyisocyanate component (d) in a volume ratio of 1:1 were sprayed for 1 second directly downwards from a height of 50 cm under the same foaming conditions (the gun was fixed) to measure the cream time and rise time for evaluation of reactivity. The numerical values were average values of the time measurement values determined visually by the trained specialized panelists (10 panelists).

[Dripping Property]

Using the above spray foam device and gun and ensuring that the spray pattern had a shape of a perfect circle, a mixed liquid was sprayed under the same foaming conditions for 2 seconds towards one point from a distance of 1 min the direction of a plyboard which was assumed to be a wall surface of a house and placed vertically (length 900 mm×width 450 mm), and the maximum horizontal width and maximum longitudinal width (vertical direction) of the formed foam were measured using a steel square (unit: mm). The maximum longitudinal width which is less than or equal to 2 times the maximum horizontal width was evaluated as good (o). When the initial reactivity is not sufficient, the sprayed mixed liquid tends to drip, and the longitudinal width of the foam tends to be more than or equal to 2 times the horizontal width of the foam.

[Contractile Property]

For the evaluation of the contractile property, a bamboo skewer was inserted into a foam right after the spray foaming was completed, and the contact point between the bamboo skewer and the foam surface was marked. The foam and the bamboo skewer were left at 20° C. for one day, the position of the contact point between the bamboo skewer and the foam surface was marked again and the difference from the contact point of the previous day was evaluated. When the difference from the previous day was 6 mm or more, it was expressed as “x (poor)”, and when the difference was 5 mm or less, it was expressed as “∘ (good)”. For the foam which contracts with a difference of 6 mm or more from the previous day, thermal insulation property required at the spraying site is not obtained and therefore additional spraying may be necessary.

[Core Density]

A cuboid of 200×200×25(t) mm was cut out from the central portion of the resulting foam, and the volume and mass thereof were measured to determine the core density. For the foam which showed a great contraction deformation, the core density was unmeasurable and could not be measured in the table.

[Determination of Difference Due to Sprayed Thickness: Core Density]

Each spray condition: in a case of a foam with a sprayed thickness of 45 mm and in a case of a foam with a sprayed thickness of 100 mm, the core density at room temperature/liquid temperature was measured and the difference between these two cases was calculated. When the difference was 0.5 kg/m³ or less, it was determined as ∘ (good), and when the difference was more than 0.5 kg/m³, it was determined as x (poor).

[Determination of Maximum Variation Due to Difference of Room Temperature/Liquid Temperature: Core Density]

For the core density values of all the foams measured in [Determination of Difference Due to Sprayed Thickness: Core density], the difference between the maximum value and the minimum value was calculated. When the difference was 1.5 kg/m³ or less, it was determined as ∘ (good), and when the difference was more than 1.5 kg/m³, it was determined as x (poor).

[Thermal Conductivity]

The thermal conductivity (unit: mW/m·K (23° C.)) was measured according to JIS A 1412-2 using a thermal conductivity measurement apparatus (product name: Auto Lambda HC-074 (200) type, produced by EKO Instruments). In JIS A 9526 (2015) (spray-applied rigid urethane foam for thermal insulation of buildings), the quality of less than or equal to 40 mW/m·K is shown as the thermal conductivity of a low-density non-bearing spray-applied rigid urethane foam: A type 3 which is used in a thermal insulation filling-up method of a wall or the like. In this field, it is recommended that this value is the standard and is satisfied.

[Hardness]

1. Asker Type F hardness: a foam which was cut out in 100×100×50(t) mm from the central portion was measured with the Asker Durometer Type F for its hardness.

2. Compressive strength: according to JIS K 7220, a foam which was cut out in 100×100×50(t) mm from the central portion was measured for its compressive strength.

[Determination of Difference Due to Sprayed Thickness: Thermal Conductivity]

Each spray condition: in a case of a sprayed thickness of 45 mm and in a case of a sprayed thickness of 100 mm, the thermal conductivity at room temperature/liquid temperature was measured and the difference between these two cases was calculated. When the difference was 1.0 mW/mK or less, it was determined as ∘ (good), and when the difference was more than 1.0 mW/mK, it was determined as x (poor).

[Determination of Maximum Variation Due to Difference of Room Temperature/Liquid Temperature: Thermal Conductivity]

For all the thermal conductivity values measured in [Determination of Difference Due to Sprayed thickness: Thermal Conductivity], the difference between the maximum value and the minimum value was calculated. When the difference was 2.0 mW/mK or less, it was determined as ∘ (good), and when the difference was more than 2.0 mW/mK, it was determined as x (poor).

[Closed Cell Ratio]

The closed cell ratio (unit: %) was measured according to ASTM D 6226.

The core portion was cut out in a cube of 25 mm×25 mm×25 mm, and the length, width, and height were measured using a caliper to measure an apparent volume. The true volume was measured according to a gas phase replacement method, using a true volume measurement apparatus (Penta pycnometer produced by Yuasa Ionics Co., Ltd). The value obtained by dividing the true volume by the apparent volume was expressed in percentage (unit: %). Generally, it can be determined that the foam is an open cell foam when the closed cell ratio is less than or equal to 10%.

The details and results of the test example 1 were as shown in Table 2.

TABLE 2

| | | | Example 1 | | | | Example 2 | | | | Example 3 | | | |
|---|---|---|---|---|---|---|---|---|---|---|---|---|---|---|
| | | | Spray condition: room temperature/liquid temperature | | | | | | | | | | | |
| | | | 0° C./ | 0° C./ | 30° C./ | 30° C./ | 0° C./ | 0° C./ | 30° C./ | 30° C./ | 0° C./ | 0° C./ | 30° C./ | 30° C./ |
| | | | 45° C. | 55° C. | 45° C. | 55° C. | 45° C. | 55° C. | 45° C. | 55° C. | 45° C. | 55° C. | 45° C. | 55° C. |
| Reactivity Cream time | | 1* | 1.3 | 1.2 | 1.1 | 0.8 | 1.5 | 1.3 | 1.2 | 0.8 | 1.2 | 1.1 | 1 | 0.6 |
| (second) | | | | | | | | | | | | | | |
| Reactivity | | 1* | 7.5 | 7.1 | 5.6 | 4.7 | 7.9 | 7.7 | 8.4 | 5.2 | 6.8 | 5.9 | 5.1 | 4.1 |
| Rise time (second) | | | | | | | | | | | | | | |
| Dripping property | | 2* | 420/ | 400/ | 410/ | 400/ | 430/ | 420/ | 415/ | 410/ | 400/ | 400/ | 410/ | 390/ |
| (maximum horizontal | | | 430 | 420 | 415 | 410 | 450 | 440 | 430 | 430 | 400 | 410 | 406 | 400 |
| width/maximum | | | | | | | | | | | | | | |
| longitudinal width: | | | | | | | | | | | | | | |
| mm) | | | | | | | | | | | | | | |
| Determination | | | ∘ | ∘ | ∘ | ∘ | ∘ | ∘ | ∘ | ∘ | ∘ | ∘ | ∘ | ∘ |
| Asker Type F hardness | | 3* | 86 | 85 | 87 | 85 | 87 | 86 | 85 | 85 | 85 | 85 | 84 | 85 |
| Compressive Strength | | 3* | 23 | 23 | 22 | 22 | 25 | 24 | 23 | 24 | 23 | 22 | 22 | 20 |
| (kPa) | | | | | | | | | | | | | | |
| Contractile | Sprayed | 3* | ∘ | ∘ | ∘ | ∘ | ∘ | ∘ | ∘ | ∘ | ∘ | ∘ | ∘ | ∘ |
| property | thickness | | | | | | | | | | | | | |
| | 45 mm | | | | | | | | | | | | | |
| | Sprayed | 3* | ∘ | ∘ | ∘ | ∘ | ∘ | ∘ | ∘ | ∘ | ∘ | ∘ | ∘ | ∘ |
| | thickness | | | | | | | | | | | | | |
| | 100 mm | | | | | | | | | | | | | |
| Core density | Sprayed | 3* | 13.3 | 13.2 | 13.4 | 14.1 | 14.4 | 13.9 | 13.5 | 14.0 | 13.2 | 13.1 | 13.1 | 13.2 |
| (kg/m3) | thickness | | | | | | | | | | | | | |
| | 45 mm | | | | | | | | | | | | | |
| | Sprayed | 3* | 13.1 | 13.2 | 13.1 | 13.8 | 13.9 | 13.5 | 13.2 | 13.6 | 13.1 | 12.8 | 12.9 | 12.9 |
| | thickness | | | | | | | | | | | | | |
| | 100 mm | | | | | | | | | | | | | |
| | Difference due | | 0.2 | 0 | 0.3 | 0.3 | 0.5 | 0.4 | 0.3 | 0.4 | 0.1 | 0.3 | 0.2 | 0.3 |
| | to sprayed | | | | | | | | | | | | | |
| | thickness | | | | | | | | | | | | | |
| | Determination | | ∘ | ∘ | ∘ | ∘ | ∘ | ∘ | ∘ | ∘ | ∘ | ∘ | ∘ | ∘ |
| | Maximum | | 1.0(14.1-13.1) | | | | 1.2(14.4-13.2) | | | | 0.4(13.2-12.8) | | | |
| | variation due | | | | | | | | | | | | | |
| | to difference | | | | | | | | | | | | | |
| | of room | | | | | | | | | | | | | |
| | temperature/ | | | | | | | | | | | | | |
| | liquid | | | | | | | | | | | | | |
| | temperature | | | | | | | | | | | | | |
| | Determination | | ∘ | | | | ∘ | | | | ∘ | | | |
| Thermal | Sprayed | 3* | 36.1 | 35.6 | 35.2 | 35 | 36.2 | 35.5 | 35.0 | 35.1 | 36.9 | 35.8 | 36.1 | 36.2 |
| conductivity | thickness | | | | | | | | | | | | | |
| (mW/mK) | 45 mm | | | | | | | | | | | | | |
| | Sprayed | 3* | 35.5 | 35.3 | 35 | 34.9 | 35.7 | 35.1 | 35.0 | 34.7 | 36.5 | 35.6 | 35.8 | 35.9 |
| | thickness | | | | | | | | | | | | | |
| | 100 mm | | | | | | | | | | | | | |
| | Difference | | 0.6 | 0.3 | 0.2 | 0.1 | 0.5 | 0.4 | 0 | 0.4 | 0.4 | 0.2 | 0.3 | 0.3 |
| | due to | | | | | | | | | | | | | |
| | sprayed | | | | | | | | | | | | | |
| | thickness | | | | | | | | | | | | | |
| | Determination | | ∘ | ∘ | ∘ | ∘ | ∘ | ∘ | ∘ | ∘ | ∘ | ∘ | ∘ | ∘ |
| | Maximum | | 1.2(36.1-34.9) | | | | 1.5(36.2-34.7) | | | | 1.3(36.9-35.6) | | | |
| | variation due | | | | | | | | | | | | | |
| | to difference | | | | | | | | | | | | | |
| | of room | | | | | | | | | | | | | |
| | temperature/ | | | | | | | | | | | | | |
| | liquid | | | | | | | | | | | | | |
| | temperature | | | | | | | | | | | | | |
| | Determination | | ∘ | | | | ∘ | | | | ∘ | | | |
| Closed cell ratio (%) | | 3* | <10 | <10 | <10 | <10 | <10 | <10 | <10 | <10 | <10 | <10 | <10 | <10 |
| Comprehensive determination | | | ∘ | | | | ∘ | | | | ∘ | | | |
| | | | | | | | | | | | Comparison Example 1 | | | |
| | | | | | | | | | | | Spray condition: room | | | |
| | | | | | | | | | | | temperature/liquid temperature | | | |
| | | | | | | | | | | | 0° C./ | 0° C./ | 30° C./ | 30° C./ |
| | | | | | | | | | | | 45° C. | 55° C. | 45° C. | 55° C. |

| Reactivity Cream time | | 1* | 1.7 | 1.6 | 1.5 | 1.3 |
|---|---|---|---|---|---|---|
| (second) | | | | | | |
| Reactivity | | 1* | 6.6 | 5.7 | 5.5 | 4.6 |
| Rise time (second) | | | | | | |
| Dripping property | | 2* | 450/ | 430/ | 420/ | 400/ |
| (maximum horizontal | | | 430 | 430 | 415 | 400 |
| width/maximum | | | | | | |
| longitudinal width: | | | | | | |
| mm) | | | | | | |
| Determination | | | ∘ | ∘ | ∘ | ∘ |
| Asker Type F hardness | | 3* | 84 | 85 | 85 | 84 |
| Compressive Strength | | 3* | 21 | 21 | 21 | 20 |
| (kPa) | | | | | | |
| Contractile | Sprayed | 3* | ∘ | ∘ | ∘ | ∘ |
| property | thickness | | | | | |
| | 45 mm | | | | | |
| | Sprayed | 3* | ∘ | ∘ | ∘ | ∘ |
| | thickness | | | | | |
| | 100 mm | | | | | |
| Core density | Sprayed | 3* | 14.1 | 14.2 | 13.2 | 13.7 |
| (kg/m3) | thickness | | | | | |
| | 45 mm | | | | | |
| | Sprayed | 3* | 12.4 | 13.7 | 12.5 | 13.5 |
| | thickness | | | | | |
| | 100 mm | | | | | |
| | Difference due | | 1.7 | 0.5 | 0.7 | 0.2 |
| | to sprayed | | | | | |
| | thickness | | | | | |
| | Determination | | x | ∘ | x | ∘ |
| | Maximum | | 1.8(14.2-12.4) | | | |
| | variation due | | | | | |
| | to difference | | | | | |
| | of room | | | | | |
| | temperature/ | | | | | |
| | liquid | | | | | |
| | temperature | | | | | |
| | Determination | | x | | | |
| Thermal | Sprayed | 3* | 38.8 | 37 | 36.8 | 35.2 |
| conductivity | thickness | | | | | |
| (mW/mK) | 45 mm | | | | | |
| | Sprayed | 3* | 36 | 34.6 | 34.9 | 35 |
| | thickness | | | | | |
| | 100 mm | | | | | |
| | Difference | | 2.8 | 2.4 | 1.9 | 0.2 |
| | due to | | | | | |
| | sprayed | | | | | |
| | thickness | | | | | |
| | Determination | | x | x | x | ∘ |
| | Maximum | | 4.2(38.8-34.6) | | | |
| | variation due | | | | | |
| | to difference | | | | | |
| | of room | | | | | |
| | temperature/ | | | | | |
| | liquid | | | | | |
| | temperature | | | | | |

| | |
|---|---|
| Determination | x |

| | | | | | |
|---|---|---|---|---|---|
| Closed cell ratio (%) | 3* | <10 | <10 | <10 | <10 |

| | |
|---|---|
| Comprehensive determination | x |

1*Spraying method-1—Spraying for 1 second directly downwards from a height of 50 cm towards a piece of paper placed on the floor (gun fixed)
2*Spraying method-2—Spraying for 2 seconds towards a plywood installed on a wall at a distance of 100 cm (gun fixed)
3*Spraying method-3—Spraying in each thickness towards a plyboard equipped with a releasable film (900 × 600 mm) installed on a wall at a distance of about 50 cm, while traversing sideways

For a spray-applied rigid polyurethane foam for thermal insulation of buildings, the thickness of the sprayed foam is usually assumed to be around 100 mm. In comparison, when the thickness of the sprayed foam is 45 mm, the density tends to vary and the thermal conductivity tends to worsen because the cell condition deteriorates. Therefore, even when the sprayed thickness is 100 mm, for example, a case is also considered in which the thickness of 50 mm is sprayed twice, and in this case, compared to a case of one time spraying, the variation of the density and the deterioration of the thermal conductivity tend to occur.

However, in the present test example 1, in Example 1, with the thickness of 45 mm, reactivity, dripping property, contraction, cell condition, core density and thermal conductivity were good even under any ambient temperature condition in consideration of the summer time (30° C.) and winter time (0° C.), and even under either condition of 45° C. and 55° C. in consideration of variation of the liquid temperature.

In addition, Examples 2 and 3 also exhibited good reactivity, dripping property, contraction, cell condition, core density and thermal conductivity as in Example 1.

On the other hand, in Comparison Example 1, the contraction was large, the cell condition was bad, and the variation ranges of the core density and the thermal conductivity were also wide.

### Test Example 2

For Example 1 and Comparison Example 1, a foam was produced in the same way as in the spraying method-3 in the test example 1 except that the thickness of the sprayed foam was 50 mm or 80 mm, and an SEM photo of cells was taken to observe the cell condition.

[Cell Condition] (Average Diameter and Distribution of Cell Diameters)

The evaluation was carried out according to the following method.

A cuboid of 200×200×25(t) mm was cut out from the central portion of the resulting foam.

The cuboid was cut out such a way that the cuboid would have a parallel surface and perpendicular surface with regard to the foaming direction (spraying direction). Then, an SEM photo of a cross section of the cuboid (magnification of ×40, imaging apparatus name, the desktop scanning electron microscope NeoScope™ JCM-6000, company name JEOL Ltd.) was taken and the cell condition was observed.

According to the following determination criteria, the cell condition was evaluated by specialized panelists (10 panelists). For the distribution, 50 cells were evenly selected from the entire area of the observation zone, and each cell diameter was measured to show the distribution thereof. For the distribution, 50 cells were evenly selected from each zone, and each cell diameter was measured to show the distribution range thereof.

The average diameter was an average value of the above cell diameters.

(Determination of Cell Condition)

∘ (good): the average cell diameter is small and the distribution width is small (The average cell diameter is from 100 to 400 μm, and the distribution width of cell diameters is up to 300 μm)

x (poor): the average cell diameter is large and the distribution width is large

(The average cell diameter is more than 400 μm, and the distribution width of cell diameters is more than 300 μm. When even one specialized panelist judges x (poor), the evaluation is determined as x (poor). In the comprehensive determination, if there is a x even in one item, it is determined as x.)

The results were as shown in Table 3.

TABLE 3

| | | | | | Comparison | |
|---|---|---|---|---|---|---|
| | | | Example 1 | | Example 1 | |
| | | | Spray condition: room | | | |
| | | | temperature/liquid temperature | | | |
| | | | 0° C./45° C. | 30° C./45° C. | 0° C./45° C. | 30° C./45° C. |
| Cell | Parallel to | Distribution | 200-400 | 200-400 | 400-600 | 400-700 |
| diameter | foaming | Average | 300 | 300 | 500 | 600 |
| A* (μm) | direction | diameter | | | | |
| | Perpendicular | Distribution | 150-300 | 200-400 | 400-500 | 400-600 |
| | to foaming | Average | 200 | 250 | 400 | 500 |
| | direction | diameter | | | | |
| Cell | Parallel to | Distribution | 200-400 | 200-400 | 400-500 | 150-500 |
| diameter | foaming | Average | 300 | 300 | 500 | 300 |
| B* (μm) | direction | diameter | | | | |
| | Perpendicular | Distribution | 100-250 | 150-300 | 200-300 | 150-400 |
| | to foaming | Average | 150 | 200 | 300 | 200 |
| | direction | diameter | | | | |
| Determination | | Distribution | ∘ (Maximum | | x (Maximum | |
| | | | distribution width 200) | | distribution width 350) | |
| | | Average | ∘ (Average diameter | | x (Average diameter | |
| | | diameter | 150~300) | | 200~600) | |
| Comprehensive determination | | | ∘ | | x | |

Spraying method-3—Spraying in each thickness towards a plyboard equipped with a releasable film (900 × 600 mm) installed on a wall at a distance of about 50 cm, while traversing sideways
Cell diameter A*: The thickness of sprayed foam is 50 mm
Cell diameter B*: The thickness of sprayed foam is 80 mm

Example 1 showed a stable and good cell condition despite the difference of the thickness of the sprayed foam and temperature change.

On the other hand, Comparison Example 1 showed large average diameters and wide range of changes due to the temperature change and the difference of the sprayed thickness.

In Examples 1 to 3 in which a foaming agent contained an amine carbonate salt, compared to Comparison Example 1 in which any amine carbonate salt was not used, the cell condition was stable, and the influence due to the changes of spray conditions such as the temperature change and the sprayed thickness was small.

1. A method for producing an open cell rigid polyurethane foam, comprising foaming a mixed liquid of (1) as polyol-containing composition comprising (a) a polyol mixture, (b) a catalyst and (c) a foaming agent, and (2) a polyisocyanate component,
wherein the foaming agent consists of water and an adduct of an amine compound having a primary or secondary amino group(s) and carbon dioxide,
the amount of the water is 10 to 80 parts by mass based on 100 parts by mass of the polyol mixture, and
the amount of the adduct is 1 to 20 parts by mass based on 100 parts by mass of the polyol mixture.

2. The production method of claim 1, wherein the polyol mixture comprises:
a polyol obtained by subjecting alkylene oxide to ring-opening addition polymerization using an initiator having 2 to 8 functional groups, and which has a hydroxyl value of 100 to 900 mg KOH/g, and
a polyether polyol obtained by subjecting alkylene oxide to ring-opening addition polymerization using an initiator having 2 to 4 functional groups which does not contain a nitrogen atom, and which has a hydroxyl value of 10 to 80 mg KOH/g.

3. The production method of claim 1, wherein the cream time of the mixed liquid of the polyol-containing composition and the polyisocyanate component is less than or equal to 1.5 seconds.

4. The production method of claim 1, wherein the mixture ratio (volume ratio) of the polyol-containing composition to the polyisocyanate component is 1:0.5 to 1:1.5.

5. The production method claim 1, wherein the core density of the open cell rigid polyurethane foam is less than or equal to 25 kg/m³.

6. The production method of claim 1, wherein the thermal conductivity of the open cell rigid polyurethane foam is less than or equal to 40 mW/m·K.

7. The production method of claim 1, wherein the closed cell content of the open cell rigid polyurethane foam is less than or equal to 10%.

8. The production method of claim 1, wherein the compressive strength of the open cell rigid polyurethane foam is 10 to 40 kPa.

9. The production method of claim 1, wherein said amine compound having a primary or secondary amino group(s) is an alkylamine compound or an alkanolamine compound.

10. The production method of claim 1, wherein the catalyst is an amine catalyst.

11. The production method of claim 1, wherein said polyol-containing composition further comprises a flame retardant and a foam stabilizer.

12. The production method of claim 1, wherein the foaming is carried out by a spraying method.

13. An open cell rigid polyurethane foam obtained by the production method of claim 1 to 12.

14. A polyol-containing composition for producing an open cell rigid polyurethane foam with a polyisocyanate component, the composition comprising (a) a polyol mixture, (b) a catalyst, and (c) a foaming agent,
wherein the foaming agent consists of water and an adduct of a primary or secondary amine compound and carbon dioxide,
the amount of water is 10 to 80 parts by mass based on 100 parts by mass of the polyol mixture, and
the amount of the adduct is 1 to 20 parts by mass based on 100 parts by mass of the polyol mixture.

15. The polyol-containing composition of claim 14, wherein the polyol mixture comprises:
a polyol which is obtained by subjecting alkylene oxide to ring-opening addition polymerization using an initiator having 2 to 8 functional groups, and which has a hydroxyl value of 100 to 900 mg KOH/g, and
a polyether polyol which is obtained by subjecting alkylene oxide to ring-opening addition polymerization using an initiator having 2 to 4 functional groups which does not contain a nitrogen atom, and which has a hydroxyl value of 10 to 80 mg KOH/g.
